(19) United States
(12) Patent Application Publication
(10) Pub. No.: US 2015/0325136 A1
(43) Pub. Date: Nov. 12, 2015

(54) CONTEXT-AWARE ASSISTANT

(71) Applicants: Jeffrey C. Sedayao, San Jose, CA (US); Sherry S. Chang, El Dorado Hills, CA (US)

(72) Inventors: Jeffrey C. Sedayao, San Jose, CA (US); Sherry S. Chang, El Dorado Hills, CA (US)

(21) Appl. No.: 14/272,198

(22) Filed: May 7, 2014

(51) Int. Cl. G09B 19/00; G09B 5/06

(52) U.S. Cl. CPC G09B 19/00; G09B 5/06

(57) ABSTRACT

Methods, systems, and computer program products that inform the user as to how best to speak or otherwise interact with others in a particular social context. Sensors may be used to capture information about a user's surroundings in near real time. This information represents contextual inputs that may be used to identify the particular social context. Once the context is identified, one or more behavioral recommendations may be generated, particular to this context, and provided to the user. In an embodiment, a determination of behavioral recommendations may also be informed by the user's input of a persona which he wishes to express in this context.

### BACKGROUND

People often find themselves in social or professional situations where it is unclear how to act. Proper behavior or language for a particular social or business context can be difficult to ascertain if the context is unfamiliar to a person. For example, a person may find himself in a foreign country but may not know the language or customs peculiar to that context, i.e., that particular country or region. The person wishes to interact in a polite manner and not offend. In another example, a business person may be attending a convention of people with whom he wishes to do business. He may be, for example, a software salesman at an insurance industry conference. Here, the salesman may not be aware of the jargon of the industry or the issues currently facing the industry. He therefore finds himself in an unfamiliar social/professional context, unsure of what to say to attendees or how to enter conversations. The salesman wishes to engage people, display some knowledge of the industry, and be welcomed.

Existing means for the addressing such problems are limited. Published materials may be available to allow a person to prepare for some situations. Phrase books for foreign languages are available for travelers; a person preparing to do business with a particular industry can study industry newsletters and journals to learn the appropriate issues and buzzwords, for example. Such approaches may require long hours of study in advance in order to be useful. Moreover, the information gained may be broad and not specific for a particular social or professional interaction. Nor is such information necessarily available in real time, when it may be needed most. A tourist in a particular region may need to know how to politely order a particular regional dish from a waiter who speaks in a particular regional dialect or accent; the salesman may need to know the jargon associated with a particular issue facing his prospective customers when the subject arises in conversation.

### BRIEF DESCRIPTION OF THE DRAWINGS/FIGURES

FIG. 1 is a block diagram illustrating the system described herein, according to an embodiment.

FIG. 2 is a flow chart illustrating processing of the system described herein, according to an embodiment.

FIG. 3 is a block diagram illustrating a context determination module, according to an embodiment.

FIG. 4 is a flow chart illustrating the context determination process, according to an embodiment.

FIG. 5 is a block diagram illustrating a recommendation module, according to an embodiment.

FIG. 6 is a flow chart illustrating recommendation determination, according to an embodiment.

FIG. 7 illustrates an embodiment featuring a mobile device and a remote server.

FIG. 8 illustrates an embodiment featuring rule refinement and learning.

FIG. 9 illustrates a computing environment of an embodiment.

In the drawings, the leftmost digit(s) of a reference number identifies the drawing in which the reference number first appears.

### DETAILED DESCRIPTION

An embodiment is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

Disclosed herein are methods, systems, and computer program products that may inform the user as to how best to speak or otherwise interact with others in a particular context. Sensors may be used to capture information about a user's surroundings in near real time. This information represents contextual inputs that may be used to identify the particular context. Once the context is identified, one or more behavioral recommendations may be generated, particular to this context, and provided to the user. In an embodiment, a determination of behavioral recommendations may also be informed by the user's input of a persona which he wishes to express in this context.

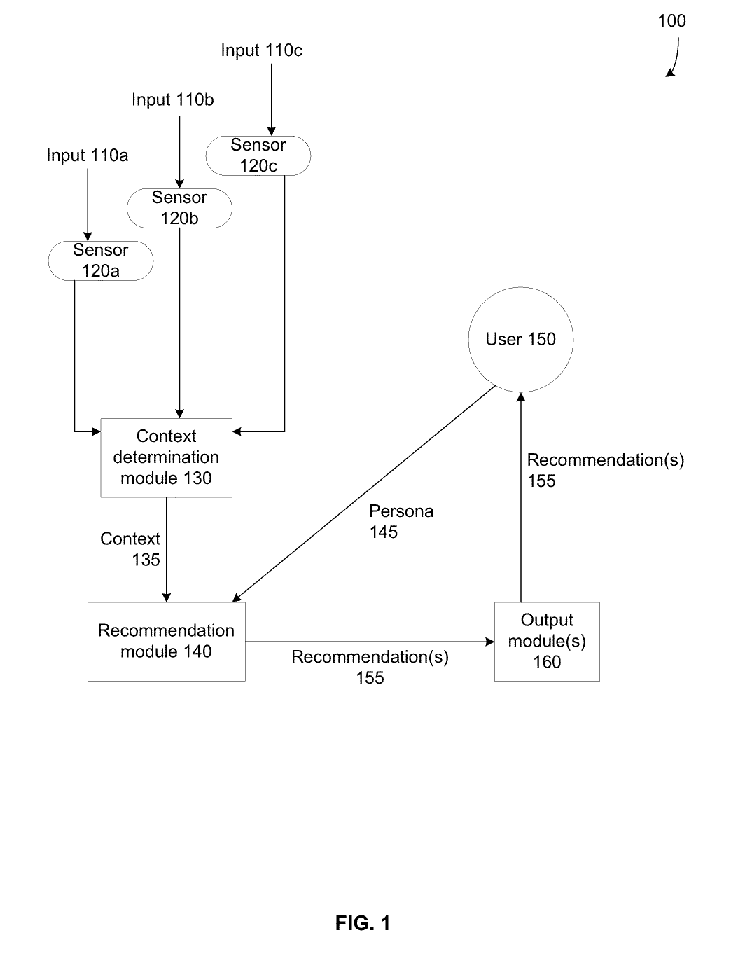

This functionality may be implemented with a system that is illustrated in FIG. 1 according to an embodiment. One or more sensors 120a . . . 120c may be used to capture corresponding contextual inputs 110a . . . 110c. The sensors 120a . . . 120c may include, for example, a microphone, a camera, a geolocation system, or other devices. These sensors may be incorporated in a user's computing device, such as a tablet computer, a smart phone, or a wearable computing device such as a smart watch or Google Glass®, for example, so that they may be exposed to a particular environment or context. In an alternative embodiment, some or all such sensors may be in communication with, but not incorporated in, such a computing device. The contextual inputs 110a . . . 110c may be, for example, location data, or audio, image, or video data that ultimately may be used to determine the context. Image or video data may capture physical surroundings of a user 150; location data may signify the geographical position of the user; and audio data may contain words that are being spoken in the vicinity of the user, or background noises that may represent clues as to a particular context. While three sensors and three respective inputs are shown in FIG. 1, it is to be understood that this is not meant to be limiting, and any number of sensors and inputs may be present in alternative embodiments.

The contextual inputs 110 may be sent to a context determination module 130. In an embodiment, this module may be implemented in hardware, software, firmware, or any combination thereof. The context determination module 130 may be embodied in the computing device of the user. The contextual inputs 110 may be used by context determination module 130 to identify a particular context, specified by data 135. Context determination module 130 may include rule-based logic to determine the context, and is discussed below in greater detail.

The context 135 may then be sent to a recommendation module 140 that generates one or more behavioral recommendations 155 for the user on the basis of the context 135. In an embodiment, recommendation module 140 may be implemented in hardware, software, firmware, or any combination thereof. The recommendation module 140 may also be implemented in the computing device of the user.

Alternatively, the recommendation module 140 may be implemented in a computing device external to the user's computing device. For example, the recommendation module may be implemented in a remotely located server or other computer that may be accessed via a network, such as the Internet. In such an embodiment, the context 135 may be sent to a server that incorporates recommendation module 140. Communications between the user's computing device and such a remote computer may be implemented using any data communications protocol known to persons of ordinary skill in the art. The recommendation module 140 may generate recommendation(s) 155 using rule based logic in an embodiment; recommendation module 140 will be discussed in greater detail below.

In the embodiment of FIG. 1, the user may also provide a persona 145 to recommendation module 140. The persona 145 may be a representation a type of person or personality that the user 150 seeks to project. For example, in a room full of insurance executives, the user 150 wishes to appear to be someone who works in the insurance industry. In another example, the tourist visiting a restaurant in Montreal may wish to appear to be a French-Canadian. In the illustrated embodiment, such a persona 145 may be provided by the user 150 to the recommendation module 140. The persona 145 may then be used by recommendation module 140 along with the context 135, to generate recommendation(s) 155. In such an embodiment, the recommendation(s) 155 may be particular to the context 135 and persona 145. In alternative embodiments, the user may not provide a persona 145, in which case the recommendation(s) 155 are generated on the basis of context 135.

The recommendation(s) 155 may take the form of text, audio, or video data that describe recommended behavior for the user 150. Recommendation(s) 155 may be sent to one or more output modules 160. Output modules 160 may include, for example, audio processing and output software and/or hardware, to include speakers or earpieces. In this case, the recommendation(s) 155 may be presented to user 150 as synthesized speech, for example. Alternatively or in addition, output modules 160 may include a visual display screen and the supporting software and hardware, to visually provide the recommendation(s) 155 to the user 150, as text, video, and/or images.

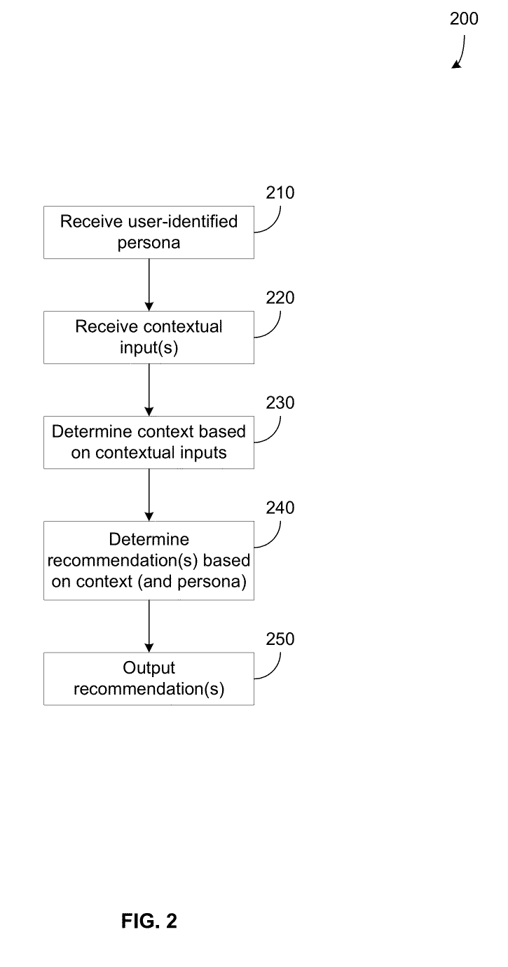

The processing of the system described herein is illustrated generally in FIG. 2, according to an embodiment. At 210, a persona identified by the user may be received. As noted above, in alternative embodiments, no persona is provided by the user. At 220, contextual inputs may be received. At 230, a context may be determined, based on the contextual inputs. At 240, one or more recommendations may be determined, based on the determined context. If a persona is provided by the user, the recommendations may be developed on the basis of both the context and the persona. At 250, the determined recommendations may be output to the user.

It is to be understood that, while the operations shown in FIG. 2 may take place in the order indicated, alternative sequences are possible in alternative embodiments.

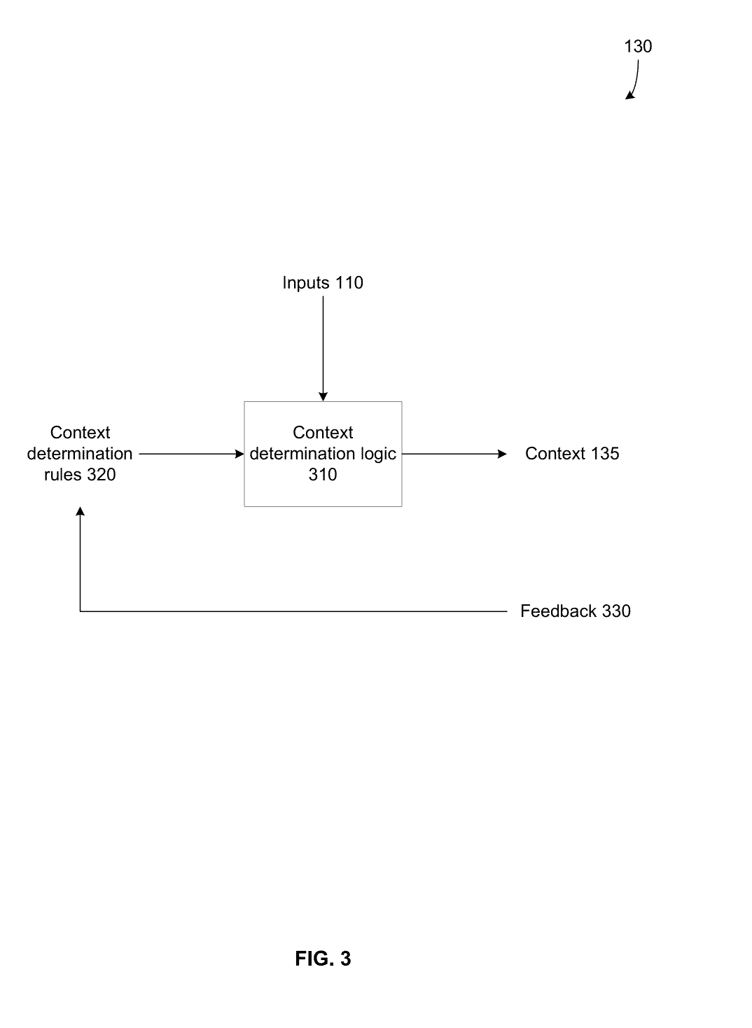

A context determination module 130 is illustrated in FIG. 3, according to an embodiment. In this illustration, context determination logic 310 may operate by the application of one or more context determination rules 320 to contextual inputs 110. In an embodiment, the information collected as contextual inputs 110 may require processing before the context determination rules are applied. Analog inputs may have to be converted to a digital form, for example. In addition, if context determination is implemented as a table lookup, the contextual inputs 110 may need to be formatted in a manner consistent with the table.

The result of this application of context determination rules 320 may include a particular context 135. In an embodiment, the set of context determination rules 320 is not necessarily static. In some embodiments, the context determination rules 320 may change on the basis of received feedback 330. Context determination feedback 330 may result, for example, from a determined context 135 that proves not to be completely accurate. In such a case, the context determination feedback 330 may come from the user. Alternatively, feedback 330 may take the form of subsequent contextual input. Such feedback may be used to alter the context determination rules 320 to improve future performance. As would be understood by a person of ordinary skill in the art, such an alteration of the context determination rules 320 may be implemented as a machine learning process.

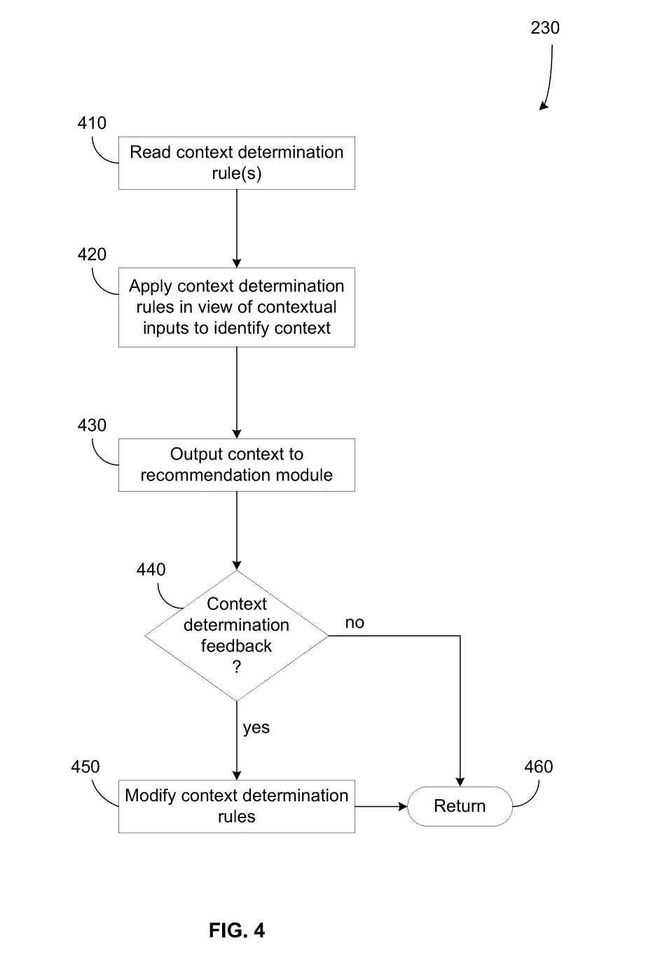

The processing 230 performed by the context determination module 130 is illustrated in FIG. 4, according to an embodiment. At 410, the set of one or more context determination rules may be read. At 420, the context determination rules may be applied to the contextual inputs, to identify a particular context. At 430, this context may be output to a recommendation module. At 440, a determination may be made as to whether context determination feedback is available. If so, then the context determination rules may be modified as appropriate at 450. Otherwise, the process may conclude at 460.

It is to be understood that, while the operations shown in FIG. 4 may take place in the order indicated, alternative sequences are possible in alternative embodiments.

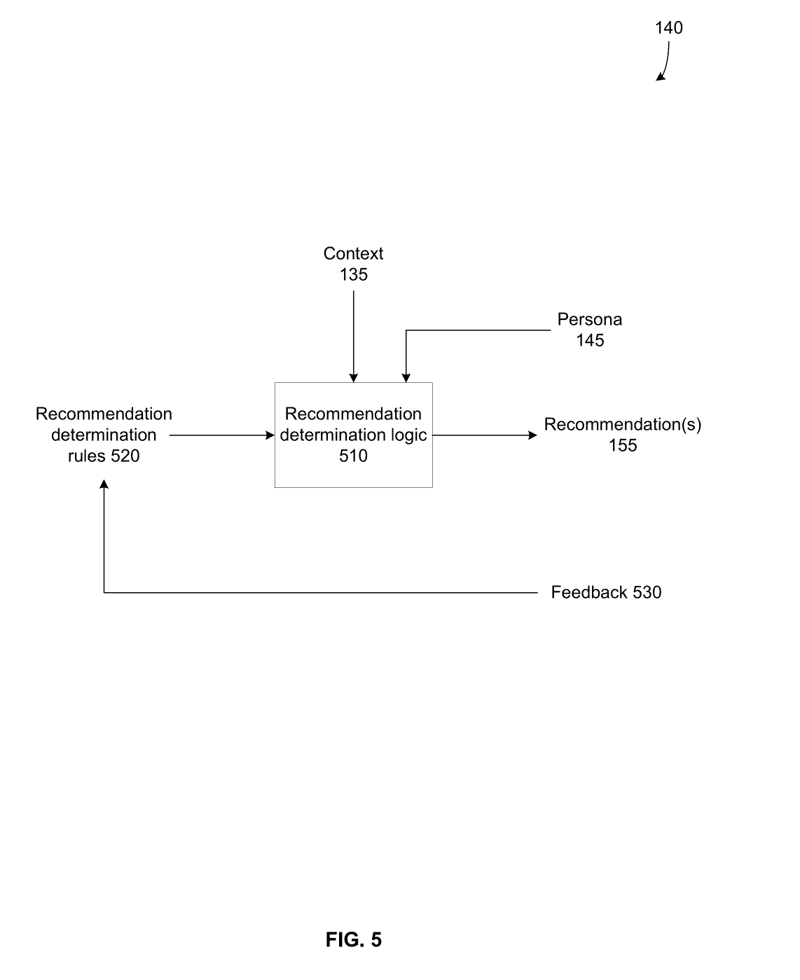

A recommendation module 140 is illustrated in FIG. 5, according to an embodiment. Recommendation determination logic 510 may operate by the application of one or more recommendation determination rules 520 to context 135. In the illustrated embodiment, persona 145 is also provided to recommendation determination logic 510 by the user. The result of this application of recommendation determination rules 520 may include one or more recommendations 155. As noted above, in alternative embodiments, a persona 145 is not provided. In such a case, the recommendation determination rules 520 are applied to the context 135 to produce recommendations 155.

In some embodiments, the recommendation determination rules 520 may change on the basis of received feedback 530. Recommendation feedback 530 may result, for example, from a recommendation that is not appropriate. In such a case, the recommendation determination feedback 530 may come from the user or other source. Such feedback 530 may be used to modify the recommendation determination rules 520 to improve future performance. As would be understood by a person of ordinary skill in the art, such an alteration of the recommendation determination rules 520 may be implemented as a machine learning process.

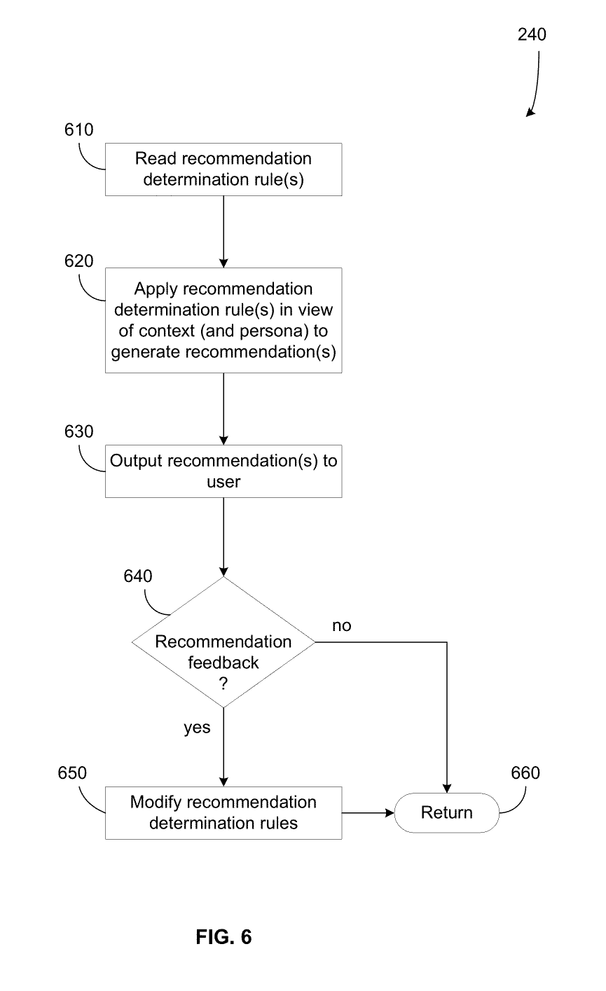

The operation of recommendation module 140 (process 240) is illustrated in FIG. 6, according to an embodiment. At 610, one or more recommendation determination rules may be read from memory. At 620, the recommendation determination rules may be applied to a determined context (and persona, if present) to generate one or more recommendations. At 630, the recommendations may be output to the user. At 640, a determination may be made as to whether any recommendation feedback is available. If so, then at 650, the recommendation determination rules may be modified in accordance with the recommendation feedback. Otherwise, the process may conclude at 660.

It is to be understood that, while the operations shown in FIG. 6 may take place in the order indicated, alternative sequences are possible in alternative embodiments.

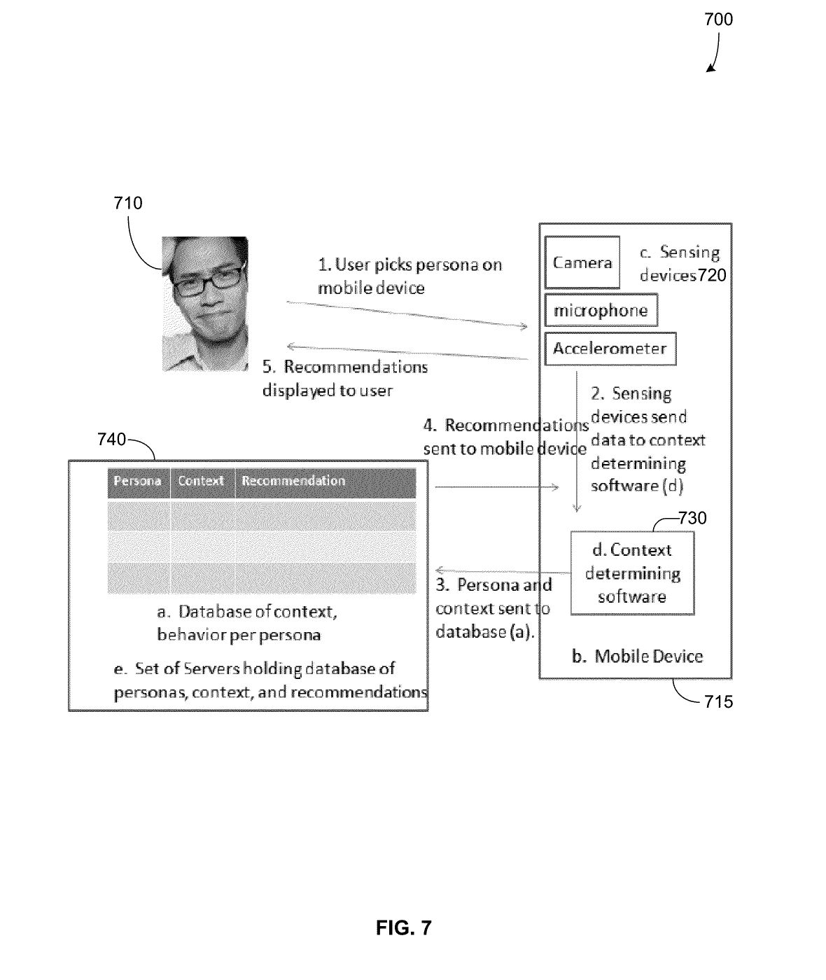

A particular embodiment of the system described herein is illustrated in FIG. 7. In this example, the user's computing device is a mobile device, such as a smartphone. The user 710 first picks a persona on the mobile device 715. In an embodiment, the persona may be chosen from a predefined menu of possibilities. A number of the sensing devices 720, such as a camera, microphone, and/or an accelerometer provide contextual input data to a context determination module, shown here as context determining software 730 executing on the mobile device 715. The context determining software 730 then identifies the context and sends a representation of the context to a recommendation module 740. The mobile device 715 also forwards the persona to the recommendation module 740. In the illustrated embodiment, the recommendation module 740 is implemented in a set of one or more servers that contain a database of personas, contexts, and corresponding recommendations. Such a database may implement the recommendation module 740 discussed above and, in particular, may include a set of recommendation determination rules. One or more recommendations may be read from the database as functions of a context and persona. In this embodiment, the server(s) are located in a location that is remote from the user's mobile device 715. The resulting recommendations may then be sent from the database in the server(s) to the user's mobile device 715 and then displayed to the user 710.

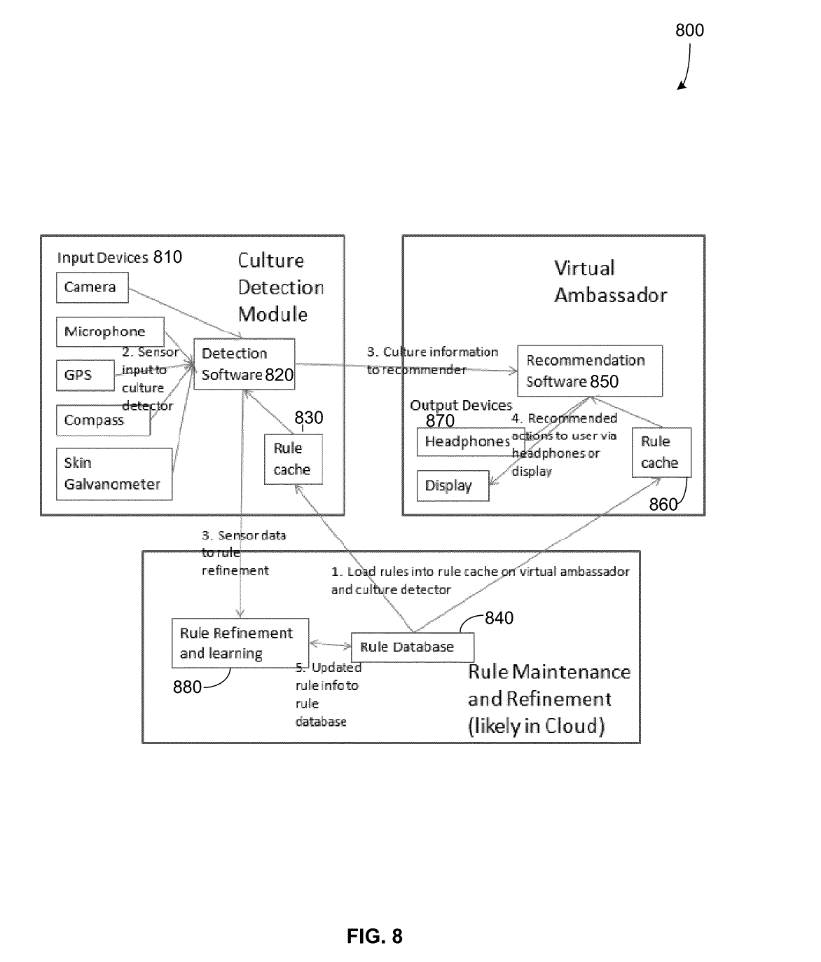

An alternative embodiment is illustrated in FIG. 8. The illustrated system may provide recommendations to a user in a foreign country or culture, for example. Here, the sensors are shown as input devices 810, such as a camera, microphone, a global positioning system (GPS) module, and a skin galvanometer, in a user's computing device. The contextual inputs captured by the sensors are then provided to a context determination module implemented here as detection software 820. The detection software 820 determines a context. In this case, the context is a particular culture. The detection software 820 applies context determination rules, read from a rule cache 830, to the contextual inputs captured by the sensors. This rule cache 830 may represent a subset of rules that are stored in a rule database 840 that is maintained external to the user's computing device, e.g., in a remote location accessible via a network (“the cloud”).

A representation of the context (i.e., culture) determined by the detection software 820 is sent to a recommendation module implemented here as recommendation software 850. The recommendation software 850 may apply rules stored in its own rule cache 860 (that, again, may be a subset of rules stored in the remote rule database 840) to the received culture information. The recommendation(s) output by the recommendation software 850 are shown as recommended actions that may be conveyed to the user through one or more output devices 870, such as headphones or a visual display.

In the illustrated embodiment, the rules database 840 may be modified by logic shown as a rule refinement and learning module 880. This logic receives sensor input as feedback, and uses this feedback to update the rule database 840.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, modules composed of such elements, and so forth.

Examples of software may include software components, computer programs, application programs, system programs, machine programs, operating system software, middleware, firmware, software modules, routines, subroutines, functions, methods, procedures, software interfaces, application program interfaces (API), instruction sets, computing code, code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

The terms software and firmware, as used herein, may refer to a computer program product including a computer readable medium having computer program logic stored therein to cause a computer system to perform one or more features and/or combinations of features disclosed herein. This computer program logic may represent control logic to direct the processing of the computer. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, random access memory (RAM), read-only memory (ROM), or other data storage device or tangible medium.

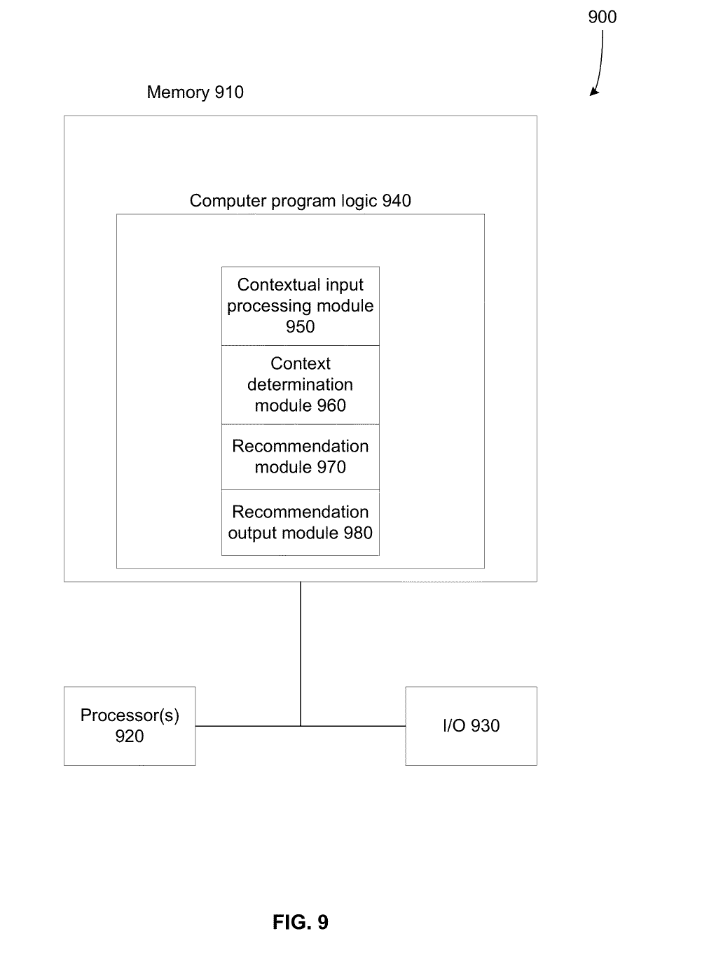

A computing system that executes such software/firmware is shown in FIG. 9, according to an embodiment. The illustrated system 900 may represent a processor unit and may include one or more processor(s) 920 and may further include a body of memory 910. Processor(s) 920 may include one or more central processing unit cores and/or a graphics processing unit having one or more GPU cores. Memory 910 may include one or more computer readable media that may store computer program logic 940. Memory 910 may be implemented as a hard disk and drive, a removable media such as a compact disk, a read-only memory (ROM) or random access memory (RAM) device, for example, or some combination thereof. Processor(s) 920 and memory 910 may be in communication using any of several technologies known to one of ordinary skill in the art, such as a bus or point-to-point interconnect. Computer program logic 940 contained in memory 910 may be read and executed by processor(s) 920. One or more I/O ports and/or I/O devices, shown collectively as I/O 930, may also be connected to processor(s) 920 and memory 910. I/O 930 may include sensors for capturing contextual input, and may also include output components, such as audio speakers or earpieces and a visual display, for providing recommendations to the user.

Computer program logic 940 may include logic that embodies some or all of the processing described above. In the illustrated embodiment, computer program logic 940 may include a contextual input processing module 950. This module may be responsible for receiving contextual inputs and processing them for purposes of the context determination process. For example, as discussed above, spoken language and images captured by sensors may be converted to a form suitable for the application of context determination rules. Computer program logic may also comprise a context determination module 960. This module may be responsible for determination of a context on the basis of the contextual inputs, as shown in FIGS. 3 and 4. Computer program logic may also comprise a recommendation module 970. This module may be responsible for determination of a recommendation on the basis of the context and a persona (if available), as shown in FIGS. 5 and 6. Computer program logic may also comprise a recommendation output module 980. This module may be responsible for providing the recommendations(s) to the user in an accessible form, such as text or audio.

System 900 of FIG. 9 may be embodied in a user's computing device. In an alternative embodiment, the recommendation module may be executed in a separate processing system, such as a remote server, and may not be present in the user's computing device.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

The following examples pertain to further embodiments.

Example 1 is a system for providing behavioral recommendations to a user, comprising: a processor; and a memory in communication with said processor, said memory for storage of a plurality of modules for directing said processor. Said modules comprise a contextual input processing module configured to direct said processor to receive contextual inputs from a user's environment; a context determination module configured to direct said processor to determine a context of the user on the basis of the contextual inputs; a recommendation module configured to determine one or more behavioral recommendations for the user, based on the context; and a recommendation output module configured to output the one or more behavioral recommendations to the user.

In example 2, the system of example 1 further comprises one or more sensors in the user's environment configured to capture said contextual inputs from the user's environment and provide said contextual inputs to be received by said contextual input processing module.

In example 3, the sensors, processor and memory of the system of example 2 are incorporated in one or more of a smart phone or a wearable computing device.

In example 4, the context determination module of the system of example 1 is configured to read one or more context determination rules; and apply the one or more context determination rules to the contextual inputs to determine the context.

In example 5, the context determination module of the system of example 4 is further configured to: receive context determination feedback in response to the determined context; and modify the context determination rules on the basis of the context determination feedback.

In example 6, the contextual inputs of the system of example 1 comprise one or more of geolocation inputs, audio inputs, and visual inputs.

In example 7, the recommendation module of the system of example 1 is configured to determine the one or more behavioral recommendations on the basis of a persona provided by the user.

In example 8, the recommendation module of the system of example 1 is configured to: read one or more recommendation rules; and apply the one or more recommendation rules to the context to determine the one or more behavioral recommendations.

In example 9, the recommendation module of the system of example 1 is configured to: receive recommendation feedback in response to the behavioral recommendations; and modify the recommendation rules on the basis of the recommendation feedback.

Example 10 is a method of providing behavioral recommendations to a user, comprising: at a computing device, receiving contextual inputs from an environment of the user; determining a context on the basis of the contextual inputs; determining one or more behavioral recommendations for the user, based on the context; and outputting the one or more behavioral recommendations to the user.

In example 11, the determination of a context in the method of example 10 comprises: reading one or more context determination rules; and applying the one or more context determination rules to the contextual inputs to determine the context.

Example 12 is the method of example 11, where the determination of a context further comprises: receiving context determination feedback in response to the determined context; and modifying the context determination rules on the basis of the context determination feedback.

Example 13 is the method of example 10, wherein the contextual inputs comprise one or more of geolocation inputs, audio inputs, and visual inputs.

Example 14 is the method of example 10, wherein the one or more behavioral recommendations are further determined on the basis of a persona provided by the user.

Example 15 is the method of example 10, wherein the determination of one or more behavioral recommendations comprises: reading one or more recommendation rules; and applying the one or more recommendation rules to the context to determine the one or more behavioral recommendations.

Example 16 is the method of example 10, where the determination of one or more behavioral recommendations further comprises: receiving recommendation feedback in response to the behavioral recommendations; and modifying the recommendation rules on the basis of the recommendation feedback.

Example 17 is one or more computer readable media comprising having computer control logic stored thereon for providing behavioral recommendations to a user, the computer control logic comprising logic configured to cause a processor to: receive contextual inputs from an environment of a user; determine a context on the basis of the contextual inputs; determine one or more behavioral recommendations for the user, based on the context; and output the one or more behavioral recommendations to the user.

Example 18 is the one or more computer readable media of example 17, wherein the determination of a context comprises: reading one or more context determination rules; and applying the one or more context determination rules to the contextual inputs to determine the context.

Example 19 is the one or more computer readable media of example 17, wherein the computer control logic is further configured to cause the processor to: receive context determination feedback in response to the determined context; and modify the context determination rules on the basis of the context determination feedback.

Example 20 is the one or more computer readable media of example 17, wherein the contextual inputs comprise one or more of geolocation inputs, audio inputs, and visual inputs.

Example 21 is the one or more computer readable media of example 17, wherein the one or more behavioral recommendations are further determined on the basis of a persona provided by the user.

Example 22 is the one or more computer readable media of example 17, wherein the determination of one or more behavioral recommendations comprises: reading one or more recommendation rules; and applying the one or more recommendation rules to the context to determine the one or more behavioral recommendations.

Example 23 is the one or more computer readable media of example 17, wherein the computer control logic is further configured to cause the processor to: receive recommendation feedback in response to the behavioral recommendations; and modify the recommendation rules on the basis of the recommendation feedback.

Example 24 is a system for providing behavioral recommendations to a user, comprising: a processor; and a memory in communication with said processor, said memory for storage of a plurality of modules for directing said processor. The modules comprise: a contextual input processing module configured to direct said processor to receive contextual inputs from a user's environment; a context determination module configured to direct said processor to determine a context of the user on the basis of the contextual inputs; a recommendation module configured to determine one or more behavioral recommendations for the user, based on one or more of the context and a persona provided by the user; and a recommendation output module configured to output the one or more behavioral recommendations to the user.

Example 25 is the system of example 24, further comprising one or more sensors in the user's environment configured to capture said contextual inputs from the user's environment and provide said contextual inputs to be received by said contextual input processing module.

Example 26 is the system of example 25, wherein said sensors, processor and memory are incorporated in one or more of a smart phone or a wearable computing device.

Example 27 is the system of example 24, wherein the context determination module is configured to: read one or more context determination rules; and apply the one or more context determination rules to the contextual inputs to determine the context.

Example 28 is the system of example 27, wherein said context determination module is further configured to: receive context determination feedback in response to the determined context; and modify the context determination rules on the basis of the context determination feedback.

Example 29 is the system of example 24, wherein the contextual inputs comprise one or more of geolocation inputs, audio inputs, and visual inputs.

Example 30 is the system of example 24, wherein said recommendation module is configured to: read one or more recommendation rules; and apply the one or more recommendation rules to the context to determine the one or more behavioral recommendations.

Example 31 is the system of example 24, wherein said recommendation module is configured to: receive recommendation feedback in response to the behavioral recommendations; and modify the recommendation rules on the basis of the recommendation feedback.

Example 32 is a method of providing behavioral recommendations to a user, comprising: at a computing device, receiving contextual inputs from an environment of the user; determining a context on the basis of the contextual inputs; determining one or more behavioral recommendations for the user, based on one or more of the context and a persona provided by the user; and outputting the one or more behavioral recommendations to the user.

Example 33 is the method of example 32, wherein said determination of a context comprises: reading one or more context determination rules; and applying the one or more context determination rules to the contextual inputs to determine the context.

Example 34 is the method of example 33, said determination of a context further comprising: receiving context determination feedback in response to the determined context; and modifying the context determination rules on the basis of the context determination feedback.

Example 35 is the method of example 32, wherein the contextual inputs comprise one or more of geolocation inputs, audio inputs, and visual inputs.

Example 36 is the method of example 32, wherein said determination of one or more behavioral recommendations comprises: reading one or more recommendation rules; and applying the one or more recommendation rules to the context to determine the one or more behavioral recommendations.

Example 37 is the method of example 32, said determination of one or more behavioral recommendations further comprising: receiving recommendation feedback in response to the behavioral recommendations; and modifying the recommendation rules on the basis of the recommendation feedback.

Example 38 is one or more computer readable media comprising having computer control logic stored thereon for providing behavioral recommendations to a user, the computer control logic comprising logic that, when executed, implement a method or realize a system as claimed in any preceding claim.

Example 39 is a machine readable medium including code, when executed, to cause a machine to perform the method of any of examples 10 to 16 and 32-37.

Example 40 is an apparatus to perform the method as recited in any of examples 10-16 or 32-37.

Example 41 is an apparatus for providing behavioral recommendations to a user, comprising: means for receiving contextual inputs from an environment of the user; means for determining a context on the basis of the contextual inputs; means for determining one or more behavioral recommendations for the user, based on the context; and means for outputting the one or more behavioral recommendations to the user.

Example 42 is the apparatus of example 41, wherein means for determining a context comprises: means for reading one or more context determination rules; and means for applying the one or more context determination rules to the contextual inputs to determine the context.

Example 43 is the apparatus of example 42, said means for determination of a context further comprising: means for receiving context determination feedback in response to the determined context; and means for modifying the context determination rules on the basis of the context determination feedback.

Example 44 is the apparatus of example claim 41, wherein the contextual inputs comprise one or more of geolocation inputs, audio inputs, and visual inputs.

Example 45 is the apparatus of example 41, wherein the one or more behavioral recommendations are further determined on the basis of a persona provided by the user.

Example 46 is the apparatus of example 41, wherein said means for determination of one or more behavioral recommendations comprises: means for reading one or more recommendation rules; and means for applying the one or more recommendation rules to the context to determine the one or more behavioral recommendations.

Example 47 is the apparatus of example 41, said means for determination of one or more behavioral recommendations further comprising: means for receiving recommendation feedback in response to the behavioral recommendations; and means for modifying the recommendation rules on the basis of the recommendation feedback.

What is claimed is:

1. A system for providing behavioral recommendations to a user, comprising:
a processor; and
a memory in communication with said processor, said memory for storage of a plurality of modules for directing said processor, said modules comprising:
a contextual input processing module configured to direct said processor to receive contextual inputs from a user's environment;
a context determination module configured to direct said processor to determine a context of the user on the basis of the contextual inputs;
a recommendation module configured to determine one or more behavioral recommendations for the user, based on the context; and
a recommendation output module configured to output the one or more behavioral recommendations to the user.

2. The system of claim 1, further comprising one or more sensors in the user's environment configured to capture said contextual inputs from the user's environment and provide said contextual inputs to be received by said contextual input processing module.

3. The system of claim 2, wherein said sensors, processor and memory are incorporated in one or more of a smart phone or a wearable computing device.

4. The system of claim 1, wherein the context determination module is configured to:
read one or more context determination rules; and
apply the one or more context determination rules to the contextual inputs to determine the context.

5. The system of claim 4, wherein said context determination module is further configured to:
receive context determination feedback in response to the determined context; and
modify the context determination rules on the basis of the context determination feedback.

6. The system of claim 1, wherein the contextual inputs comprise one or more of geolocation inputs, audio inputs, and visual inputs.

7. The system of claim 1, wherein the recommendation module is configured to determine the one or more behavioral recommendations on the basis of a persona provided by the user.

8. The system of claim 1, wherein said recommendation module is configured to:
read one or more recommendation rules; and
apply the one or more recommendation rules to the context to determine the one or more behavioral recommendations.

9. The system of claim 1, wherein said recommendation module is configured to:
receive recommendation feedback in response to the behavioral recommendations; and
modify the recommendation rules on the basis of the recommendation feedback.

10. A method of providing behavioral recommendations to a user, comprising:
at a computing device, receiving contextual inputs from an environment of the user;
determining a context on the basis of the contextual inputs;
determining one or more behavioral recommendations for the user, based on the context; and
outputting the one or more behavioral recommendations to the user.

11. The method of claim 10, wherein said determination of a context comprises:
reading one or more context determination rules; and
applying the one or more context determination rules to the contextual inputs to determine the context.

12. The method of claim 11, said determination of a context further comprising:
receiving context determination feedback in response to the determined context; and
modifying the context determination rules on the basis of the context determination feedback.

13. The method of claim 10, wherein the contextual inputs comprise one or more of geolocation inputs, audio inputs, and visual inputs.

14. The method of claim 10, wherein the one or more behavioral recommendations are further determined on the basis of a persona provided by the user.

15. The method of claim 10, wherein said determination of one or more behavioral recommendations comprises:
reading one or more recommendation rules; and
applying the one or more recommendation rules to the context to determine the one or more behavioral recommendations.

16. The method of claim 10, said determination of one or more behavioral recommendations further comprising:
receiving recommendation feedback in response to the behavioral recommendations; and
modifying the recommendation rules on the basis of the recommendation feedback.

17. One or more computer readable media comprising having computer control logic stored thereon for providing behavioral recommendations to a user, the computer control logic comprising logic configured to cause a processor to:
receive contextual inputs from an environment of a user;
determine a context on the basis of the contextual inputs;
determine one or more behavioral recommendations for the user, based on the context; and
output the one or more behavioral recommendations to the user.

18. The one or more computer readable media of claim 17, wherein the determination of a context comprises:
reading one or more context determination rules; and
applying the one or more context determination rules to the contextual inputs to determine the context.

19. The one or more computer readable media of claim 17, wherein the computer control logic is further configured to cause the processor to:
receive context determination feedback in response to the determined context; and
modify the context determination rules on the basis of the context determination feedback.

20. The one or more computer readable media of claim 17, wherein the contextual inputs comprise one or more of geolocation inputs, audio inputs, and visual inputs.

21. The one or more computer readable media of claim 17, wherein the one or more behavioral recommendations are further determined on the basis of a persona provided by the user.

22. The one or more computer readable media of claim 17, wherein the determination of one or more behavioral recommendations comprises:
reading one or more recommendation rules; and
applying the one or more recommendation rules to the context to determine the one or more behavioral recommendations.

23. The one or more computer readable media of claim 17, wherein the computer control logic is further configured to cause the processor to:
receive recommendation feedback in response to the behavioral recommendations; and
modify the recommendation rules on the basis of the recommendation feedback.
